(19) United States
(12) Patent Application Publication
(10) Pub. No.: US 2010/0099439 A1
(43) Pub. Date: Apr. 22, 2010

(54) METHOD AND APPARATUS FOR REALIZATION OF A PUBLIC WARNING SYSTEM

(75) Inventors: Behrouz Aghili, Commack, NY (US); Marian Rudolf, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/615,896

(22) Filed: Nov. 10, 2009

Related U.S. Application Data
(63) Continuation-in-part of application No. 12/404,914, filed on Mar. 16, 2009.
(60) Provisional application No. 61/113,092, filed on Nov. 10, 2008.
(60) Provisional application No. 61/037,057, filed on Mar. 17, 2008.
(60) Provisional application No. 61/055,509, filed on May 23, 2008.

(51) Int. Cl. H04W 68/00; H04W 4/00

(52) U.S. Cl. 455/458; 455/466

(57) ABSTRACT

Disclosed are methods and apparatus for the dissemination of public warning system (PWS) information. In one embodiment, a wireless transmit/receive unit receives a Paging Request message that includes PWS notification information. In another embodiment, a base station is configured to transmit a Paging Request message that includes public warning system (PWS) notification information. In another embodiment, a WTRU begins a procedure for the assignment of a radio resource for the WTRU. The procedure may be, for example, a Random Access Channel (RACH) procedure. The WTRU may monitor a control channel for an assignment message related to the radio resource. In response to receiving a PWS notification, the WTRU may terminate the resource assignment procedure.

### CROSS REFERENCE TO RELATED APPLICATIONS

This application claims the benefit of U.S. Provisional Application No. 61/113,092, filed Nov. 10, 2008, which is hereby incorporated by reference herein in its entirety. This application is a continuation in part of U.S. patent application Ser. No. 12/404,914, filed on Mar. 16, 2009, which claims the benefit of U.S. Provisional Application No. 61/037,057, filed on Mar. 17, 2008, and U.S. Provisional Application No. 61/055,509, filed on May 23, 2008, each of which is hereby incorporated by reference herein in its entirety.

### TECHNICAL FIELD

The subject matter disclosed relates to wireless communications.

### BACKGROUND

Public Warning Systems (PWS) are of great utility in the modern world. Traditionally, PWS have been implemented in many parts of the world by relying upon conventional radio (AM, FM, and the like) and/or television (TV) Emergency Broadcast channels to urgently announce the occurrence of events that pose significant threats in terms of life or property within a certain geographical area. Due to the widespread availability of wireless networks (e.g., cellular networks), both in terms of coverage and wireless device penetration rates, the use of wireless networks has become a viable option to replace or supplement radio/TV delivery mechanisms for PWS messages. The objectives of PWS, however, may pose challenges for wireless networks in terms of delivery guarantees, notification timeliness, information accuracy and the amount of detail required to deliver useful PWS messages to users.

For example, a wireless device that is currently receiving or transmitting data over a wireless network may not be able to receive other information, such as a PWS message, until the device is finished receiving or transmitting the data. Thus, the wireless device may not receive the PWS message from the wireless network at all (if the wireless network has since stopped transmitting the PWS message) or may receive the PWS message after the emergency has already occurred.

Similarly, at the time a PWS message is sent from the wireless network, the wireless device may be operating in a low-power mode (e.g., an idle mode), which may generally be used to conserve battery power. In the low-power mode, rather than continuously listen for messages from the wireless network, the wireless device may reduce its power consumption by listening for messages at the beginning or end of periodic time intervals. These time intervals may reach up to several seconds or more and any reduction in the time intervals may have a negative impact on battery life and stand-by times. Furthermore, to facilitate the delivery of a PWS message to a large number of wireless devices, the wireless network may transmit the PWS message more than once to improve the probability that a significant portion of the wireless devices (including those currently in an idle mode) will receive the PWS message at some point in time. In some cases, the wireless network may repeatedly transmit the PWS message over a period lasting up to several tens of seconds in duration. For many emergency events (such as earthquakes or tornados), warnings may be issued only a few seconds before the actual occurrence of the event. Consequently, at least some of the wireless devices may not receive the PWS message until after the occurrence of the event.

An additional challenge for wireless networks may include the limited size of the network's payload data. Specifically, the amount information in a PWS message needed to effectively convey the type, scope, and/or degree of an emergency may be greater than the size of the available payload data that can be transmitted by the wireless network. Further, signals transmitted by the wireless network may include a number of overhead fields, and may carry large amounts of control information and/or information related to the translation of message contents to different languages. These additional overhead fields and control information may further limit the amount of space available to carry PWS information.

### BRIEF DESCRIPTION OF THE DRAWINGS

A more detailed understanding may be had from the following description, given by way of example and to be understood in conjunction with the accompanying drawings wherein:

FIG. 1 is a flow diagram of a PWS based on WTRU mode;

FIG. 2 is a signal flow diagram illustrating the use of System Information messaging to convey PWS information;

FIG. 3 is an illustration of the use of paging resources to convey PWS information;

FIG. 4 is a flow diagram of a method for using paging resources to convey PWS information;

FIG. 5 shows a Fast Associated Control Channel (FACCH) frame for carrying PWS information;

FIG. 6 is a detailed view of the address field in the FACCH frame of FIG. 5;

FIG. 7 is a detailed view of the length indicator field in the FACCH frame of FIG. 5;

FIG. 8 shows a method for using the FACCH frame of FIG. 6 to transmit PWS data;

FIG. 9 shows a method wherein a WTRU terminates a resource assignment procedure in response to receiving a PWS message; and

FIG. 10 is a block diagram of a WTRU and a base station configured to implement the methods and features described with reference to FIGS. 1-9.

### SUMMARY

Disclosed are methods and apparatus for the dissemination of public warning system (PWS) information. In one embodiment, a wireless transmit/receive unit comprises a receiver and a processor. The receiver is configured to receive a Paging Request message that includes PWS notification information, and the processor is configured to decode the PWS notification information. In another embodiment, a base station comprises a transmitter configured to transmit a Paging Request message that includes public warning system (PWS) notification information. In another embodiment, a WTRU begins a procedure for the assignment of a radio resource for the WTRU. The WTRU may monitor a control channel for an assignment message related to the radio resource. In response to receiving a PWS notification, the WTRU may terminate the resource assignment procedure.

### DETAILED DESCRIPTION

When referred to herein, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of device capable of operating in a wireless environment. When referred to herein, the terminology “base station” includes but is not limited to a Node-B, a wireless router, a site controller, an access point (AP), or any other type of interfacing device capable of operating in a wireless environment.

In order to overcome the problems discussed above and provide a PWS that is capable of carrying payloads of adequate size to multiple WTRUs quickly, various solutions follow that may be implemented based on the operating state of the WTRU.

Cellular technologies that may be used for the purpose of disseminating PWS information include but are not limited to networks based on technologies such as Global System for Mobile Communications (GSM), Enhanced Data Rates for GSM Evolution (EDGE) Radio Access Network (GERAN), General Packet Radio Service (GPRS), Enhanced GPRS (EGRPS), and EGPRS-2. In a GERAN-based network, PWS information may be communicated to WTRUs using, for example, Earthquake Tsunami Warning Systems (ETWS) technology. Although examples are provided below with reference to GERAN and ETWS technology, the principles described herein are applicable, mutatis mutandis, to any wireless technology suitable for the transmission/reception of PWS information.

In GSM/GPRS/EGPRS, a WTRU may be attached to both a circuit switched (CS) (GSM) domain and a packet switched (PS) (GPRS) domain at the same time. In both domains, the WTRU has a Radio Resource Control (RRC) state. In the CS domain, the WTRU may be either in RRC idle mode or RRC dedicated mode. In the PS domain, the WTRU may be in either RRC packet idle mode or RRC packet transfer mode. The modes of operation in the CS and PS domains are generally independent, which means that a WTRU may be in CS dedicated mode and PS packet idle mode at the same time.

GERAN ETWS is an example of a primary/secondary PWS notification system. According to primary/secondary notification systems, a primary notification may be sent first, and the primary notification may be followed by a secondary notification containing additional information. The secondary notification may include information that is specific to a WTRU or group of WTRUs based on, for example, geographic location, proximity to a specific event, and other information. The primary notification may be time critical, while the secondary notification may lag slightly.

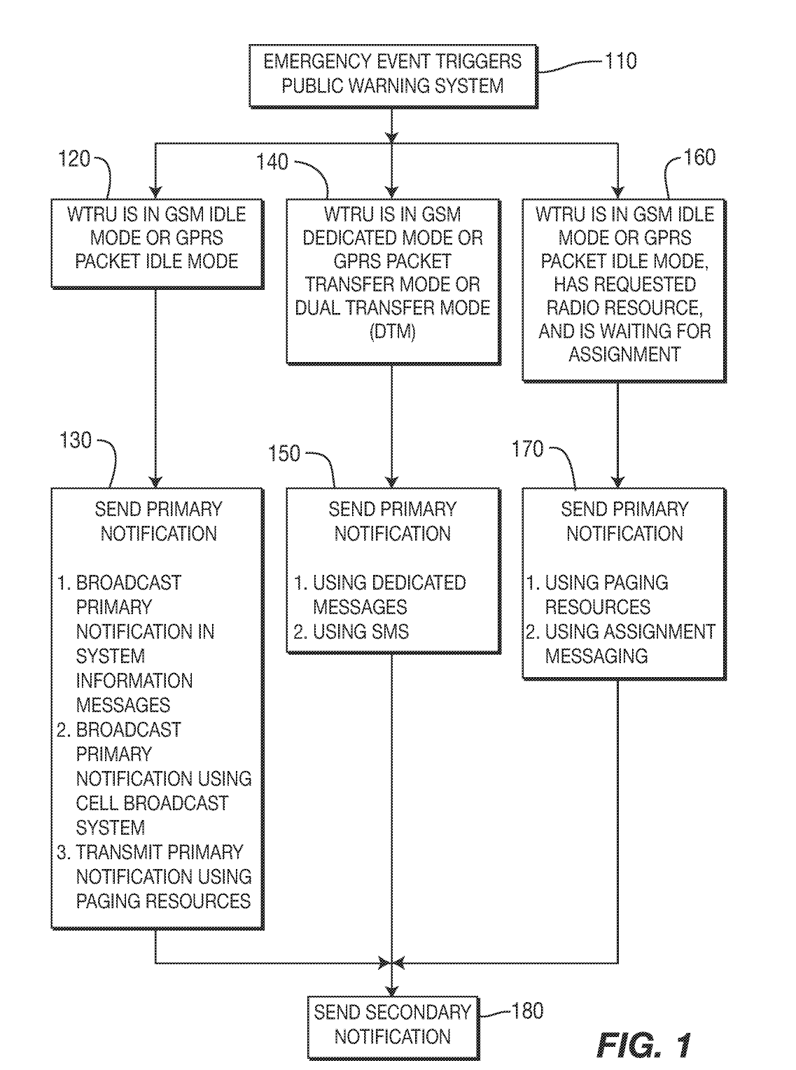

FIG. 1 shows an example method for the transmission and reception of PWS information in a primary/secondary notification system. An emergency event may trigger 110 the public warning system. In a scenario 120 where a WTRU is in GSM idle mode (CS domain) or the WTRU is in GPRS packet idle mode (PS domain), a primary notification may be transmitted 130 by a base station to the WTRU. The primary notification may be transmitted 130 to the WTRU via a system information message broadcast by the base station, via paging resources, or via Cell Broadcast System (CBS) messaging. In a scenario 140 where a WTRU is in GSM dedicated mode (CS domain) or GPRS packet transfer mode (PS domain) or dual transfer mode (DTM), the WTRU may include an active radio resource. This active resource may allow a primary PWS notification to be sent 150 via dedicated messaging or using short messaging service (SMS) messaging. In a scenario 160 where a WTRU is in GSM idle mode (CS domain) or GPRS packet idle mode (PS domain), and the WTRU has requested a radio resource but has not yet received a resource assignment message, a primary notification may be sent 170 using paging resources or it may be included in an assignment message. A secondary notification message may then be sent 180 at an appropriate time containing additional information regarding the emergency situation. The scenario specific techniques for communicating the primary notifications 130, 150, 170, as well as corresponding secondary notification message 180, will now be described in greater detail.

In the event that a WTRU is in GSM idle mode (attached to the CS domain) or GPRS packet idle mode (attached to the PS domain) (scenario 120 of FIG. 1), a new field or Information Element (IE) may be added to the System Information (or Packet System Information) message(s) indicating System Information messages will be used for broadcasting PWS information. Subsequently transmitted System Information messages may then be used for communicating both primary notifications and secondary notifications. Additionally, upon an emergency event that triggers the PWS, the base station may use the remaining resources in a multi-frame for sending the warning messages (resources that are typically used for sending other System Information messages and/or the assignment/paging messages). This means that the network may use all of the blocks that are reserved for Common Control Channels (CCCH) on the broadcast control channel (BCCH) carrier. In the case where there exists a packet common control channel (PCCCH) in the cell, the network may similarly use all the blocks (designated “B0” through “B11”) on the PCCCH time slot.

In either case, the network may send the notification for a sufficiently long period of time in order to comply with current technical requirements. For example, a PWS primary notification may be delivered over a four second time period. Since various WTRUs operating in a given geographic region will likely have differing DRX schedules, this time period may ensure the PWS primary notification is received by all WTRUs.

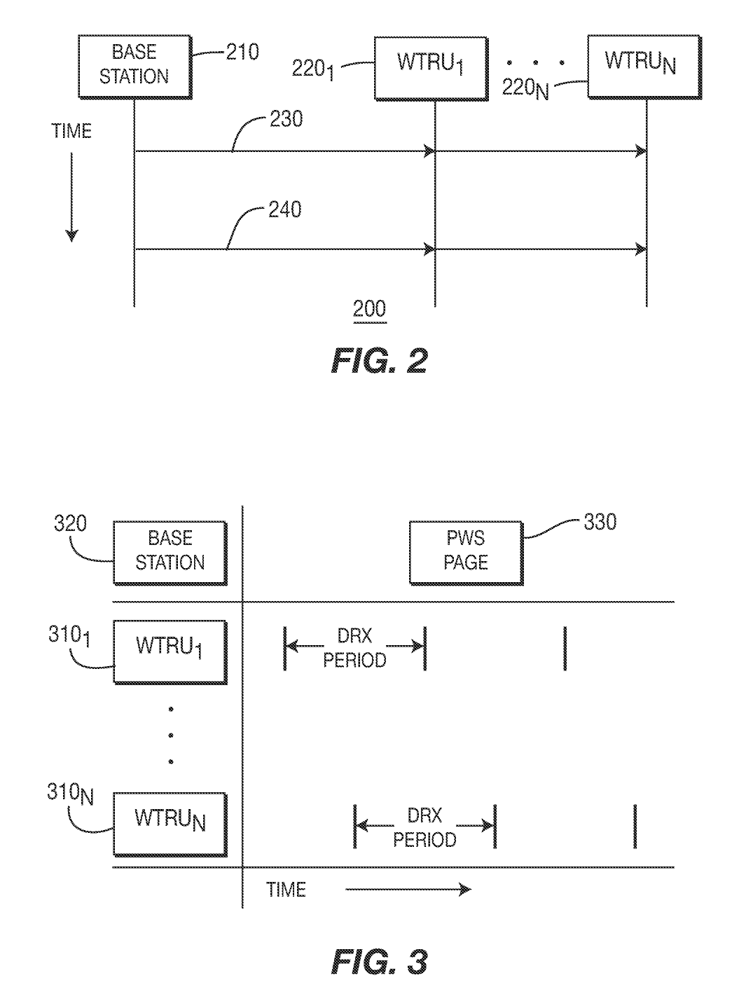

Referring to FIG. 2, a signal flow diagram 200 illustrates use of System Information messages for a mobile PWS. A base station 210 serves a plurality of WTRUs, 220₁, 220_{N}. A first System Information message 230 may be broadcast to the plurality of WTRUs, 220₁, 220_{N}, and may include an indication of PWS support by the base station 210. After some emergency event triggers activation of the PWS, the base station 210 may broadcast another System Information message 240 to the plurality of WTRUs, 220₁, 220_{N}, that includes a primary notification of the emergency. The System Information message 240 may also include the indication of PWS support as in System Information message 230.

In order to optimize the use of System Information messaging for PWS, a WTRU may be preconfigured with various PWS messages or components of PWS messages that correspond to particular emergency categories and/or actions. This preconfigured PWS information may include emergency category, action codes, immediacy of emergency event, location of emergency event, and/or other PWS data fields. This preconfigured information may be stored in the WTRU in any appropriate storage medium, such as a subscriber identity module (SIM), and may be stored in any appropriate structure, such as a look-up table.

Table 1 illustrates an example set of codes and corresponding emergency situations. The code points allow operator definable emergency descriptions that provide users a great deal of information while utilizing minimal data capacity in over-the-air messaging.

TABLE 1

| Emergency Code | Emergency Description |
|---|---|
| 1 | Tsunami |
| 2 | Earthquake |
| 3 | Shooting |
| . . . | . . . |

Table 2 below shows another example of preconfigured information indicating the duration of a given emergency event.

TABLE 2

| Code | Duration |
|---|---|
| 1 | Next 10 Minutes |
| 2 | Next Hour |
| 3 | Next 1-2 Hours |
| . . . | . . . |

When an event occurs that triggers the PWS system, the network may send a System Information message containing short code(s) and/or type field(s) corresponding to full PWS notification messages as described above. The WTRU may then receive the message, decode the short code(s) and then perform a look-up procedure of the preconfigured PWS information to determine the actual corresponding PWS message and/or action and display it to the user in a manner appropriate to the capabilities of a particular WTRU. The WTRU may also take corresponding actions (such as pre-empting ongoing voice calls, and the like).

This method may be independent of the actual delivery mechanism used by the network and therefore may apply to dedicated PWS notification messaging services and other types of messaging services such as Paging, short message service (SMS), Cell Broadcast System (CBS), that will be described below in greater detail.

The content of the PWS messages may alternatively be compressed using approaches such as, for example, Huffmann coding, symbol codes, stream codes, integer codes, and the like. Use of these coding techniques includes the exchange of “code tables” or probability tables that are similar in principle to the preconfigured PWS information as described above.

As mentioned above, preconfigured PWS information may be stored on a Universal Telecommunications System (UMTS) subscriber identity module (USIM)/Universal Integrated Circuit Card (UICC) of the WTRU, or in any other volatile or non-volatile memory structure of the WTRU.

Alternatively, the base station may transmit PWS configuration information using any one of or combination of an Internet protocol (IP)-based server using configuration protocols and over-the-air messaging, Open Mobile Alliance (OMA) messaging, radio resource control (RRC) messaging, non-access stratum (NAS) messaging, and WTRU firmware updates (over-the-air or through proprietary means such as universal serial bus (USB) and the like).

Alternatively, a WTRU may be preconfigured with code points that allow for multi-lingual support of PWS messaging. The lookup table may contain multiple language codes for each PWS code or component. Alternatively, there may be more than one stored entry in the look-up table(s) corresponding to a given PWS or component code. This may be desirable for operators in regions where multiple languages are commonly spoken.

Similar to broadcasting System Information messages containing PS information, CBS messaging may also be used for disseminating PWS messaging to WTRUs. A base station may indicate to an associated WTRU that CBS is “on” in the cell. The base station may include primary and/or secondary notification messages in extensions to one or more CBS messages. Alternatively or additionally, one or more dedicated CBS messages for communicating primary and/or secondary notification messages may be used. The WTRU may then decode the indicated Cell Broadcast Channel (CBCH) and receive the PWS information.

In addition to or in place of System Information messaging and/or CBS messaging, PWS information may be disseminated via paging resources to WTRUs in GSM idle mode and GPRS packet idle mode. The base station may use paging channels to send a primary PWS notification. To ensure that all WTRUs associated with a base station receive the paging message transmitted by the base station, the base station may transmit the paging messages over a subset of or all of the available paging channels. The base station may transmit the paging messages over the subset of or all of the paging channels for a period of time. The base station may also duplicate the transmission of the primary notification to ensure that all WTRUs receive it. In addition, if segmentation of the primary notification is necessary, the duplication may help a WTRU to receive the primary notification in any order. After receiving a paging message, a WTRU may decode the message to obtain the PWS information contained therein. The WTRU then may respond to the PWS information by indicating to a user that PWS information has been received. This may include, for example, displaying an alert message on a user interface or playing an alert sound. A displayed alert message may include, for example, a textual and/or graphical representation of the PWS information.

Different paging messages may be used to transmit PWS information to a WTRU in GSM Radio Resource Control (RRC) idle mode and GPRS packet idle mode. For example, primary and/or secondary PWS notification messages may be included in a single Paging Request or single Packet Paging Request message. Alternatively or additionally, a primary and/or secondary notification message may be spread throughout two or more Paging Request messages or two or more Packet Paging Request messages, or throughout a combination of at least one Paging Request message and at least one Packet Packing Request message.

Referring to FIG. 3, a plurality of WTRUs 310₁ . . . 310_{N} are in a DRX mode. This means that these WTRUs will periodically enter a sleep mode where each WTRU shuts down certain components to conserve battery power. During these DRX periods, the WTRU will not be listening to any paging channels and will therefore not be able to receive any PWS paging messages transmitted by base station 320. In order to ensure that WTRUs 310₁ . . . 310_{N} receive PWS paging messages, base station 320 transmits a PWS page message 330 using paging channels available to base station 320 for a period of time long enough to ensure that all WTRUs in a DRX mode receive the PWS page message 330.

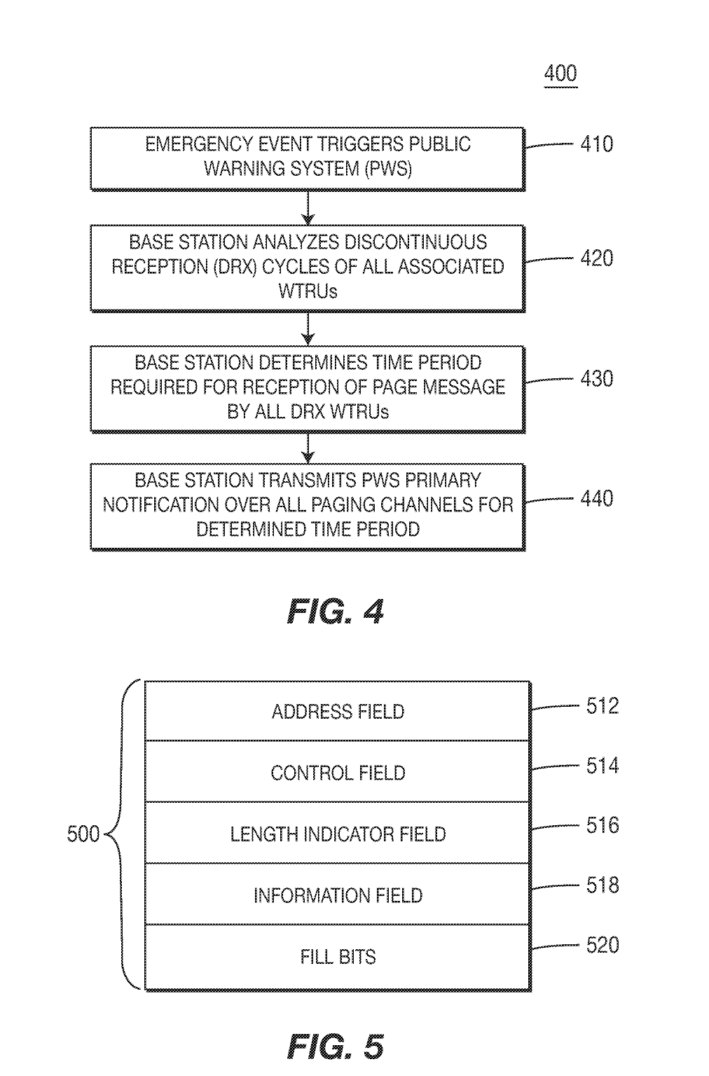

Referring to FIG. 4, a method 400 for transmitting PWS information via paging resources begins with an emergency event that triggers 410 the PWS. A base station may analyze 420 DRX cycles of all associated WTRUs. The base station may then determine 430 the time period that would facilitate reception of the PWS paging message by all WTRUs associated with the base station. The determined time period may be based on one or more parameters such as, for example, the length of the DRX cycle, a paging period length, the number of frames or multiframes sent in a paging period, an average of the number of frames or multiframes sent in a paging period, the number of WTRUs currently in DRX mode, or one or more parameter analyzed 420 by the base station related to WTRU DRX cycles. The base station then transmits 440 a PWS primary notification over all paging channels for the determined time period so that all WTRUs associated with the base station receive the PWS paging message, even those WTRUs in DRX modes of operation.

In a scenario where a WTRU is in GSM RRC dedicated mode or GPRS packet transfer mode, the WTRU may have either a stand-alone Dedicated Control Channel (SDCCH), traffic channel (TCH), or a GPRS radio resource which is called a Temporary block Flow (TBF). PWS information may be transmitted directly to the WTRU using these dedicated resources. In these cases, a base station may send a primary notification message to the WTRU using these dedicated resources.

In the case the WTRU has a TCH available, the TCH may be accompanied by two control channels for signaling purposes, the Slow Associated Control Channel (SACCH) and the Fast Associated Control Channel (FACCH). The FACCH may be used in “stealing mode”, which is a well known concept in GSM systems and refers to the FACCH stealing from TCH resources in order to convey rapid and time sensitive signaling messages. It is noted that this “stealing mode” may also be used when a WTRU is in dual transfer mode (DTM), as DTM operation includes the use of a TCH. The actual delivery of the notification may be accomplished by, for example, modifying an existing message or introducing a new message that is understood by the ETWS/PWS capable WTRUs.

In the case where a WTRU is in GPRS packet transfer mode, the base station may transmit a new Radio Link Control /Medium Access Control (RLC/MAC) Control Block containing the primary PWS notification. This message may be read by all WTRUs that are multiplexed on the same Packet Data Channel (PDCH). For increased certainty, the base station may repeat the transmission of the RLC/MAC message over several radio blocks. The actual delivery of the notification may be accomplished by, for example, modifying an existing message or introducing a new message that is understood by the ETWS/PWS capable WTRUs.

Alternatively, SMS messaging may be used to transmit PWS notifications to a WTRU in GSM dedicated mode or GPRS packet transfer mode. When a WTRU is in GSM dedicated mode, SMS messaging may be received by the WTRU from the base station over FACCH or SDCCH resources. The SMS messages, for the WTRU in GSM dedicated mode, are normally sent over the SACCH. However, due to the slow nature of the SACCH, the use of FACCH for SMS delivery in this scenario may provide improved performance. When a WTRU is in packet transfer mode, the base station may first send a primary notification in a Control Block including a new RLC/MAC message to the WTRU. Upon receipt of the primary notification, the WTRU will ignore any downlink (DL) identity (such as DL temporary block flow (TBF)) if included in the radio block header of the following RLC/MAC data blocks. The WTRU will instead decode the blocks to obtain any additional PWS information. The base station may also use a distribution type message (such as a broadcast message) that does not include any particular identity in the header.

Referring to FIG. 5, a FACCH frame 500 for carrying PWS information may include an address field 512, control field 514, length indicator field 516, information field 518, and fill bits 520. For a FACCH frame 500, the address field 512, control field 514, and length indicator field 516 may be one octet in length each. The information field 518 may be a variable number of octets in length. The fill bits 520 may be used to pad the FACCH frame 500 out to a standard size.

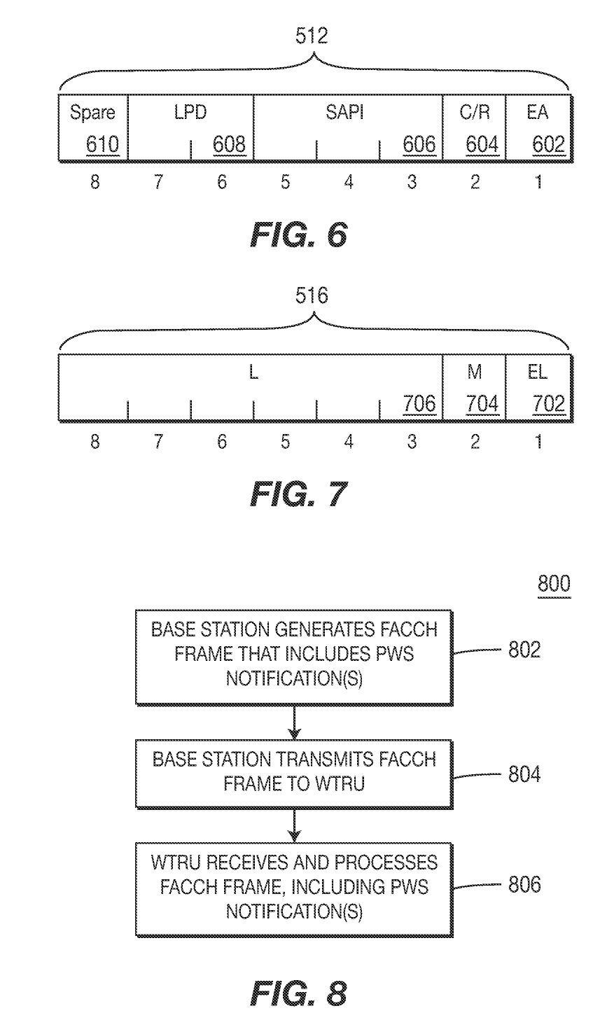

FIG. 6 shows a detailed view of the contents of the address field 512 of the FACCH frame 500. The address field 512 may include eight bits. Bit 1 of the address field 512 (shown furthest to the right) may be an extended address (EA) bit 602. Bit two of the address field 512 may be a command/response (C/R) bit 604. Bits three to five may be service access point identifier (SAPI) bits 606. Bits six and seven may be Link Protocol Discriminator (LPD) bits 608. Bit 8 (shown furthest to the left) in the address field 512 may be spare bit 610. The spare bit 610 may be used to indicate that the information field 518 includes a primary and/or secondary PWS notification message.

Alternatively or additionally, the LPD field 508 in the FACCH frame 500 may be used to indicate that the information field 518 contains PWS data. Two code points (“00”) and (“01”) may be defined for the LPD field 508. A value of “10” or “11” for the LPD field 508 may therefore be used to indicate that the information field 518 contains PWS data.

Alternatively or additionally, a value in the length indicator field 516 may be used to indicate that the information field 518 contains PWS data. FIG. 7 shows a detailed view of the length indicator field 516. Bit 1 of the length indicator field 516 (shown furthest to the right) may be an extension bit 702. Bit two of the length indicator field 516 may be a more data (M) bit 704. Bits three through eight may be length indicator (L) bits 706. According to FACCH operation, only certain lengths for the FACCH frame 500 may be permitted. Therefore, many of the possible values that the L bits 706 could represent may not be utilized. For example, the L bits 706 may have a maximum theoretical value of twenty-two, although the L bits 706 have the capacity to represent a higher number. Therefore, the value of the L bits 706 may be set to a value that the L bits 706 may not represent in typical operation, such as values above the theoretical maximum for typical operation. Such values would indicate that the information field 518 in the FAACH frame 500 contains PWS data.

FIG. 8 shows a method 800 for using a FACCH frame as described with reference to FIGS. 5-7 for the transmission of PWS data. A base station may generate 802 a FACCH frame and transmit 804 the FACCH frame to a WTRU. The WTRU may be in CS dedicated mode. The FACCH frame may include a spare bit, LPD field, and/or length indicator field that is set to indicate that the information field in the FACCH frame contains PWS data, as described above with reference to FIGS. 5-7. The WTRU may receive and process 806 the FACCH frame, including the PWS primary and/or secondary notification messages contained in the information field in the FACCH frame.

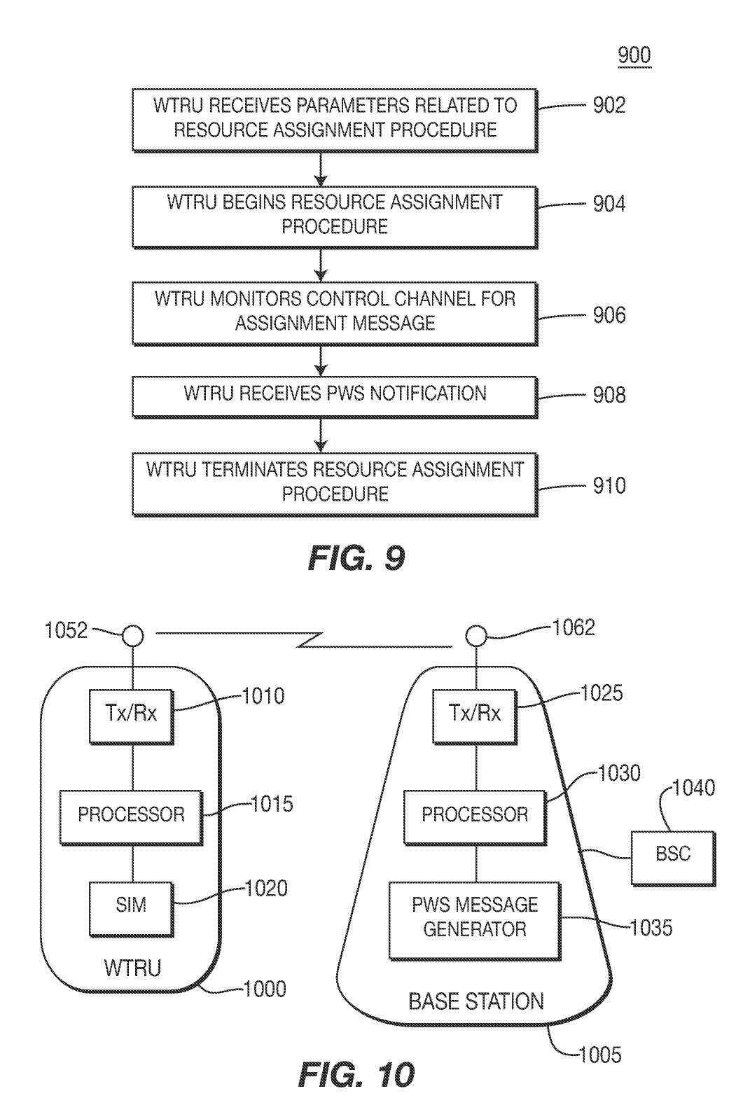

FIG. 9 shows a method 900 for receiving PWS information at a WTRU during a resource assignment procedure. Prior to beginning the resource assignment procedure, the WTRU may receive 902 one or more parameters related to how the resource assignment procedure should be performed. These parameters may relate to, for example, how many times the WTRU may retry a request for a resource, and/or specify a time period during which further request messages can be sent. The parameter related to how many times the WTRU may retry a request for a resource may be a Max Retrans parameter, and the parameter specifying a time period during which further request messages can be sent may be a Tx-integer parameter. The Max Retrans parameter may be one of the four values {1, 2, 4, or 7}, meaning that the WTRU may be in a retransmit situation for eight (total) attempts. The Tx-integer parameter defines the time period between the attempts and the allowed interval during which the WTRU may transmit another message to request a resource. An example value for the Tx-integer is 32, which defines a range of 32 consecutive TDMA frames between 217 and 248 frames after the previously sent request. Depending upon the resource assignment parameters received and their respective values, a WTRU may be configured to send request messages for several seconds.

After receiving 902 one or more parameters related to how the WTRU should request a resource, the WTRU begins 904 the resource assignment procedure. The WTRU may begin 904 the resource assignment procedure by, for example, sending a request message that indicates a request for the resource. The request message may be, for example, a Channel Request message, Packet Channel Request message, an EGPRS Packet Channel Request message, or other message. After sending 904 the request message, the WTRU may monitor 906 a control channel in order to find an assignment message that indicates an assignment for a resource as requested in the request message. The assignment message may be, for example, an Immediate Assignment message or other assignment message. The control channel may be, for example, a Common Control Channel (CCCH), Access Grant Channel (AGCH), or other control channel. The WTRU may repeat the request for the resources, according to the received parameters.

While monitoring the control channel but before receiving an assignment message, the WTRU may receive 908 a PWS notification. In response to the PWS notification, the WTRU makes no further attempts to request a radio resource. Rather, the WTRU may terminate 910 the resource assignment procedure and process the PWS notification.

In various implementations of the method 900 of FIG. 9, the WTRU may receive 908 different PWS notifications. For example, the WTRU may receive the PWS notification on a Paging Channel (PCH) or on a broadcast channel. In response to receiving the PWS notification on a PCH or on a broadcast channel, the WTRU may make a determination to not perform additional attempts to request a radio resource. The WTRU may then terminate 910 the resource assignment procedure and process the PWS information.

Alternatively or additionally, WTRU may receive 908 the PWS notification in the assignment message for which the WTRU is monitoring. The assignment message, generated and transmitted by the base station, may include an indication (for example, in the form of an IE) that the assignment message includes PWS information. The assignment message may be, for example, an Immediate Assignment message or other assignment message. The WTRU may then receive 908 the assignment message, decode the message, and determine that a PWS primary notification is included in the assignment message. The WTRU may receive 908 the assignment message on a channel such as the CCCH, the AGCH, or another channel. After receiving the assignment message, the WTRU may terminate 910 the resource assignment procedure and process the PWS information.

The resource assignment procedure described in FIG. 9 may be, for example, a GERAN Random Access Channel (RACH) procedure (which is used by a WTRU that is in CS idle mode and PS idle mode to enter dedicated mode), or may be any other procedure related to the assignment of a radio resource. The method 900 of FIG. 9 is applicable to assignment procedures related to radio resources that include but are not limited to dedicated channels, temporary block flows, radio access bearers, and/or any other type of allocation or configuration of wireless bandwidth for use by a WTRU.

FIG. 10 shows an example block diagram of a wireless communication system configurable to implement the method and features for transmission/reception of PWS information described above with reference to FIGS. 1-9. The wireless communication system includes a WTRU 100, a base station 1005, a base station controller (BSC), and may include other additional base stations, WTRUs, and network-side components (not depicted).

In addition to the components that may be found in a typical WTRU, the WTRU 1000 may include at least one transceiver (Tx/Rx) 1010, at least one processor 1015, and at least one antenna 1052. The WTRU may also additionally include a SIM card 1020 or other identification card. The processor 1015 is configured to generate and process data such as the PWS-related data described above. The transceiver 1010 is in communication with the processor 1015 and the antenna 1052 to facilitate the transmission and reception of wireless communications, including but not limited to the PWS-related information described above. For example, the processor 1015 may be configured to decode received data to recover PWS information as described above. The SIM card 1020 may include stored PWS short codes that may be accessed by the processor 1015 for decoding received PWS messages. The WTRU 1000 may also optionally include a display (not depicted) in communication with the processor 1015. The display may be based on liquid crystal display (LCD), organic light-emitting diode (OLED), or other display technology. The processor 1015 is may be configured to process the PWS-related data as described above, and communicate data to the display to render graphical and/or textual representations of the PWS-related data to a user of the WTRU.

In addition to the components that may be found in a typical base station, the base station 1005 may include at least one transceiver (Tx/Rx) 1025, at least one processor 1030, at least one antenna 1062, and a PWS message generator 1035. The processor 1030 is to process data related to PWS information as described above with reference to FIGS. 1-9. The processor 1030, the PWS message generator 1035, and/or the combination of the processor 1030 and the message generator 1035 may be configured to generate the PWS-related messages described above. The base station 1005 also may be also be configured to operate a CBS; in such an instance, the PWS message generator 1035, the processor 1030, and/or the combination of the PWS message generator 1035 and processor 1030 may be configured to generate the necessary CBS messages. The transceiver 1025 is in communications with the processor 1030, PWS message generator 1035, and antenna 1062 to facilitate the transmission and reception of wireless communications, including the PWS-related messages described above.

The base station 1005 may be in wired or wireless communication with a base station controller (BSC) 1040, as well as other additional network side components (not shown). Information related to emergency event triggers and DRX scheduling, as well as other information related to the transmission/reception of PWS information as described above, may be received and stored in BSC 1040.

The various options described above with reference to FIGS. 1-10 for the transmission/reception of PWS information may be used in various combinations so that a subset of WTRUs or all of the WTRUs within a certain area receive PWS information. For example, PWS notifications (both primary and secondary) may be sent using any combination of SMS, CBS, Paging, BCCH, Multimedia Broadcast/Multicast Service (MBMS), or any combination thereof. PWS modes for primary and secondary notifications may be different. A base station may advertise the PWS delivery mode(s) through capability or configuration bits, bit fields, information elements in System Information, or extensions to CS or PS control messages sent to WTRUs. These indications announce which PWS mode is currently supported in a cell, group of cells, or the affected Public Land Mobile Network (PLMN). When multiple PWS delivery modes are available, a WTRU may select the appropriate delivery mode based upon its respective configuration and its respective PWS rules. These PWS rules may be a function of WTRU states (CS idle/connected, PS attached/idle) and/or WTRU activity (when in a CS call, when in a PS session, and the like). The PWS rules may also include priority of how a WTRU may attempt to monitor for the occurrence of PWS messages sent by a GSM/GPRS/EGPRS base station.

Although examples are described above with respect to FIGS. 1-10 in terms of a GERAN system, the principles described above are equally applicable to other types of wireless communications systems. The principles described above are applicable to systems based on technologies including but not limited to Worldwide Interoperability for Microwave Access (WiMax), Wireless Broadband (WiBro), Institute of Electrical and Electronics Engineers (IEEE) 802.11x, UMTS/UMTS Terrestrial Radio Access Network (UTRAN), Long Term Evolution (LTE), LTE-Advanced (LTE-A), Code Division Multiple Access-2000 (CDMA2000), or any other technology that supports the transmission and/or reception of PWS information.

Although features and elements are described above with reference to FIGS. 1-10 in particular combinations, each feature and element can be used alone without the other features and elements, or in various combinations with or without other features and elements. The sub-elements of the methods and flowcharts described above may be realized in any order (including concurrently), in any combination or sub-combination. The methods or flow charts described above may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A wireless transmit/receive unit (WTRU), the WTRU comprising:
a receiver configured to receive a Paging Request message that includes public warning system (PWS) notification information; and
a processor, configured to decode the PWS notification information.

2. The WTRU of claim 1, wherein the receiver is configured to receive the Paging Request message while operating in a circuit-switched (CS) idle mode or a packet-switched (PS) idle mode.

3. The WTRU of claim 1, wherein the receiver is configured to receive the Paging Request message via a Global System for Mobile Communications (GSM) Enhanced Data Rates for GSM Evolution (EDGE) Radio Access Network (GERAN) network.

4. The WTRU of claim 1, wherein the PWS notification information relates to a primary PWS notification message.

5. The WTRU of claim 4, wherein the receiver is further configured to receive a secondary PWS notification message related to the primary PWS notification message, and wherein the processor is further configured to decode the secondary PWS notification message.

6. The WTRU of claim 1, further comprising:
a display, configured to display an alert message based on the PWS notification information.

7. A base station, the base station comprising:
a transmitter configured to transmit a Paging Request message that includes public warning system (PWS) notification information.

8. The base station of claim 7, wherein the transmitter is configured to transmit the Paging Request message to the WTRU while the WTRU operates in a circuit-switched (CS) idle mode or a packet-switched (PS) idle mode.

9. The base station of claim 7, wherein the transmitter is configured to transmit the Paging Request message to the WTRU via a Global System for Mobile Communications (GSM) Enhanced Data Rates for GSM Evolution (EDGE) Radio Access Network (GERAN) network.

10. The base station of claim 7, wherein the PWS notification information relates to a primary PWS notification message.

11. The base station of claim 10, wherein the transmitter is further configured to transmit a second Paging Request message to the WTRU, the second Paging Request message including information related to a secondary PWS notification message.

12. A method for use in a wireless transmit/receive unit (WTRU), the method comprising:
beginning a resource assignment procedure related to an assignment of a radio resource for the WTRU;
monitoring a control channel for an assignment message related to the radio resource; and
in response to receiving Public Warning System (PWS) notification information, terminating the resource assignment procedure.

13. The method of claim 12 wherein the WTRU performs the beginning the resource assignment procedure while the WTRU is in Global System for Mobile Communications (GSM) idle mode and General Packet Radio Service (GPRS) idle mode.

14. The method of claim 12 wherein the radio resource is a dedicated channel and wherein the resource assignment procedure is a Random Access Channel (RACH) procedure.

15. The method of claim 12 wherein the beginning the resource assignment procedure includes transmitting a request for the radio resource.

16. The method of claim 12 further comprising:
receiving a Max Retrans parameter and a Tx-integer parameter related to the resource assignment procedure; and
transmitting a request for the radio resource based on the Max Retrans parameter and the Tx-integer parameter.

17. The method of claim 16 wherein the request is a Channel Request message, Packet Channel Request message, or an Enhanced General Packet Radio Service (EGPRS) Packet Channel Request message.

18. The method of claim 12 further comprising:
receiving the assignment message, wherein the assignment message includes the PWS notification information.

19. The method of claim 18 wherein the assignment message is received via an Access Grant Channel (AGCH).

20. The method of claim 18 wherein the assignment message is an Immediate Assignment message.
